(19) United States
(12) Patent Application Publication
(10) Pub. No.: US 2003/0090904 A1
(43) Pub. Date: May 15, 2003

(54) Adjustable height stand with cam-lever

(76) Inventor: Yueh Ching, Taipei (TW)

Correspondence Address: BACON & THOMAS, PLLC, 625 SLATERS LANE, FOURTH FLOOR, ALEXANDRIA, VA, 22314

(21) Appl. No.: 10/291,385

(22) Filed: Nov. 12, 2002

Related U.S. Application Data
(63) Continuation-in-part of application No. 09/752,443, filed on Jan. 3, 2001.

(51) Int. Cl. F21V 21/22; A47F 5/06

(52) U.S. Cl. 362/413; 362/418; 248/125.8

(57) ABSTRACT

A work light stand, with light installed thereon, comprises an adjustable lever, with its length fixable by a fastening device; and supporting legs, hinged to said adjustable lever and maintaining said work light stand in the upright standing position. The fastening device is of a notched ring structure, where a body core pierces across the notch; and a working lever, hinged to one end of the body core, can be tightened in the notch to tighten or loosen the fastener which in turn fastens or releases between the first lever and the second lever.

### CROSS REFERENCE TO RELATED APPLICATION

This application is a continuation-in-part of application Ser. No. 09/752,443, filed Jan. 3, 2001 and entitled “Adjustable Height Stand With Cam-Lever”.

### BACKGROUND OF THE INVENTION

1. Field of the Invention

The present invention relates to a fastening device for use in a work light stand; specifically to a fastening device for a work light stand with adjustable height using a single working lever to tighten or loosen the fastening device to adjust the height of the work light stand

2. Description of the Prior Art

The work light is used extensively in many night work settings. For convenience, the conventional work light is equipped with a work light stand. As shown in FIG. 1, the work light stand 10 comprises a cross lever 11 for the installation of the work light 12 thereon, an adjustable lever 13 with its length to be fixed in position by a fastening device 14, and supporting legs 15 which are hinged to and support said adjustable lever 13 and maintain the work light stand to stand upright. Under the prior art, the adjustable lever is comprised of an upper lever 131 and a lower lever 132, where the diameter of one lever is slightly greater than that of the other, such that one can fit inside the other to adjust the combined length. The fastening device 14, comprised of a screw and a screwed socket, is installed at the juncture between the upper lever 131 and lower lever 132. The fastening device 14 locks the upper lever 131 and lower lever 132 in place and thereby fixes the heights of the work light stand by winding the screw and the screwed socket tightly together.

As the work light stand generally undergoes constant height adjustments during usage, the manner in which the adjustable lever 13 is adjusted contributes to the operational convenience of the work light stand. In the prior art, when the fastening device 14, comprised of a screw and a screwed socket, is being tightened or loosened, a user must expend greater rotational motion to unwind the screw and adjust the positions of the upper and lower levers. Because the winding of the screw determines the tightness between the upper and lower levers, the user needs to loosen the screwed socket in order to easily adjust the height of the upper and lower levers.

The object of the present invention is to provide a work light stand with a fastening device having a single lever to tighten or loosen the adjustable lever, and is suitable for use in a height adjustable work light stand.

### SUMMARY OF THE INVENTION

To overcome the inconvenience in using the conventional fastening device for the work light stand, the present invention provides a work light stand for installing work light thereon. It comprises an adjustable lever with its length fastened in place by a fastening device, and supporting legs, hinged on said adjustable lever for supporting the work light stand in the upright standing position, wherein said fastening device is a notched ring structure, and a screwed socket is connected between the two ends of the notch; one end of said screwed socket is hinged to a working lever which can tighten in between the two ends of the ring structure.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 shows a front view of the supporting frame for work light of the prior art;

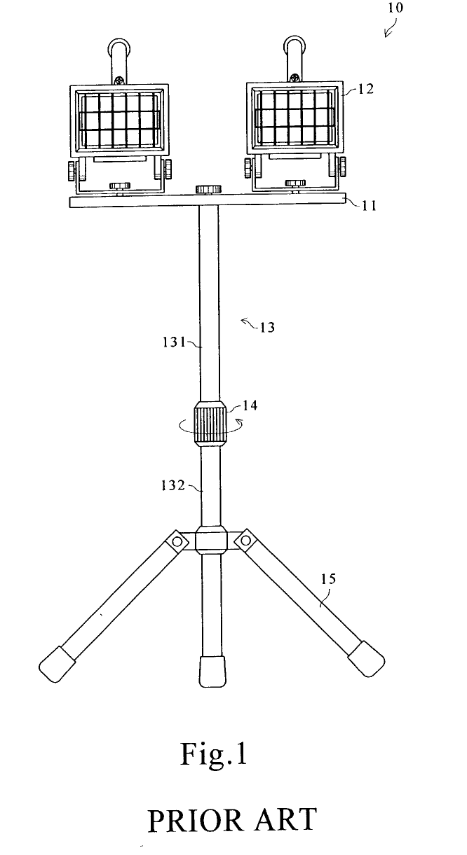

FIG. 2 shows a front view of the supporting frame for work light of the invention;

FIG. 3 shows a sectional view of the fixating mechanism during state of release of the invention; and

FIG. 4 shows a sectional view of the fixating mechanism during state of tightness of the invention.

### DETAILED DESCRIPTION OF THE INVENTION

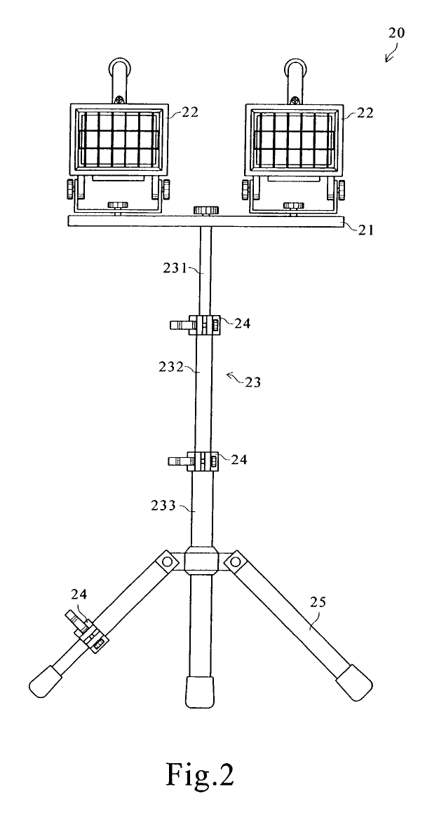

As shown in FIG. 2, the work light stand 20 of the present invention comprises a cross lever 21 for installing thereon the light 22, an adjustable lever 23 connecting to the cross lever 21 with its length fixed in place by a fastening device 24 to fix the work light stand at a desired height, and the supporting legs 25, hinged to and support the adjustable lever 23 for maintaining the work light stand in the upright standing position. The fastening device 24 comprises a working lever, which can be adjusted with single motion for tightening or loosening the fastening device, and thereby tightens or loosens the adjustable lever 23. This is distinguishable from the prior art in which multiple rotational motions are necessary for achieving gradually either the tightened or the loosened condition.

In the preferred embodiment of the present invention, the adjustable lever 23 of the work light stand 20 is comprised of a first lever 231 and a second lever 232, where the first lever 231 is connected to the cross lever 21 as shown in FIG. 2. For instance, the cross lever 21 can be fastened to one end of the first lever 231 by a screwed socket, and the second lever 232 can be hinged to a set of supporting legs 25, thus identical, as shown in FIG. 2, with how a lever 233 is hinged to the supporting legs 25 to maintain the adjustable lever 23 in the upright standing position. Then the fastening device 24 is installed at the juncture between the first lever 231 and the second lever 232 to fix the length of the adjustable lever 23 in place.

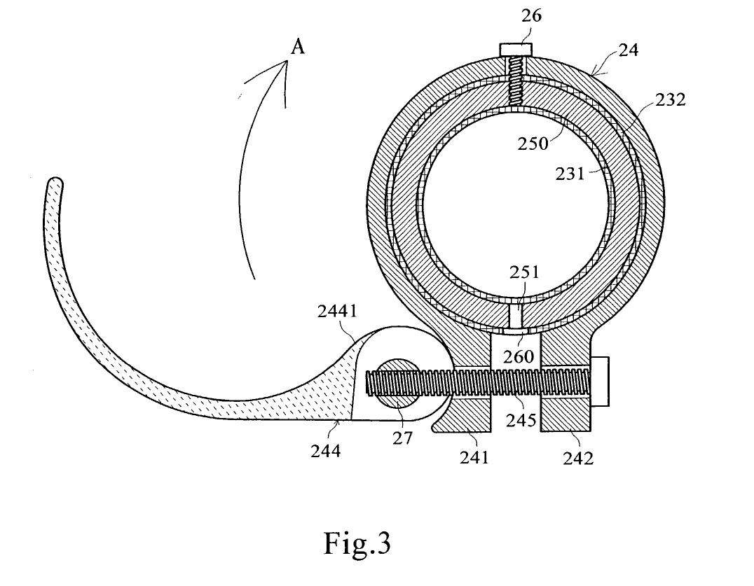

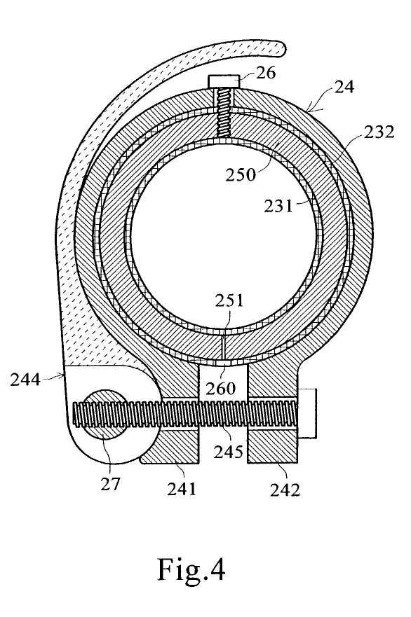

Please refer to FIG. 3 and FIG. 4, which show the sectional views of the state of tightening and loosening of the fastening device 24. In the preferred embodiment of the invention, the fastening device 24 is of a ring-shaped structure with notch and can be installed at the end portion of either the first lever 231 or the second lever 232, with the end portions having concave groove 260, and a ring-shaped plastic tube 250 having slit 251 is jointed in the interior of the second lever 232, and a screw member 26 can be used for securing the plastic tube 250 and the fastening device 24 on both the inner and outer edge of the end portion of the second lever 232, so that the tightness of the fastening device 24 can tighten and constrict the inner diameter of the plastic tube 250, so as to secure the first lever 231 to achieve the locking purpose. As shown in FIG. 3 and FIG. 4, when the fastening device 24 is installed at the junction of the first lever 231 and the second lever 232, the inside-out installing structure of the fastening device 24, the first lever 231 and the second lever 232 in order is: the first lever 231, the plastic tube 250, the second lever 232 and the fastening device 24. Furthermore, two ends 241 and 242 are formed at the notched portion of the fastening device 24, with a screw socket 245 pierced through; it is clear from FIG. 3 that one end of such screw socket 245 is to pierce through the two ends 241 and 242 of the ring-shaped structure and then joint to the pivot rod 27 of the working lever 244, so as to adjust the screw socket 245 to joint with the working lever 244 and the fastening device 24. The working lever 244 contains the cam structure 2441, thus the working lever 244 can be operated, with the pivot rod 27 as pivot, to rotate in direction A, and the cam structure 2441 is to cause the end 241 to be close to the end 242, thus constricting the second lever 232 and the plastic tube 250, and achieving the securing effect of the first lever 231. To further elaborate, the screw socket 245 can also be replaced by non-screw members (without screw threads), and there is no screw involved between the two ends 241 and 242, thus when the working lever 244 activates the end 241, the end 241 can easily be caused to be close to the other end 242.

In another preferred embodiment of the invention, since the application of the use of the fastening device 24 on the supporting frame for work light can achieve more convenience, the adjustable lever 23 of the work light stand 20 for work light can be composed of the first lever 231, the second lever 232 and the third lever 233, wherein the junction of the first lever 231 and the second lever 232 and the junction of the second lever 232 and the third lever 233 are respectively installed with the fastening device 24 to control the state of extension, as shown in FIG. 2, thus making the work light stand 20 for work light of the invention more flexible and applicable than the prior art with two extension rods concerning the height adjustment. Further, the supporting legs 25 of the work light stand 20 for work light can be formed as two extension rods and installed with the fastening device 24 thereon, so that when the work light stand 20 for work light of the invention is used for standing on the ground, the supporting legs 25 can be used conveniently for adjusting uneven grounds. For example, the fixating mechanism can also be composed of two separate ring-shaped fixers, one end for both fixers are to be fixated onto the rod with another end for both fixers being operated by single movable rod with single action, so as to control the state of tightness and looseness of the two fixers.

I claim:

1. A work light stand with a light installed thereon, the work light stand comprises:
an adjustable lever controlled by a fastening device;
supporting legs hinged to said adjustable lever for maintaining said work light stand in the upright standing position;
wherein said fastening device having a working lever and being installed at the juncture of said adjustable lever, such that said working lever tightens or loosens said fastening device with a single operating motion so that said fastening device can in turn fasten or release the adjustable length of said adjustable lever;
wherein said working lever includes a tip and is shaped and configured to axially overlap said adjustable lever when the fastening device is in a closed position; and
rotational axis of said working lever is parallel to longitudinal axis of said adjustable lever, and the tip of said working lever is shaped and configured to curve radially inwards towards said adjustable lever to minimize accidental disengagement of said working lever.

2. The work light stand as in claim 1, wherein said adjustable lever is comprised of a first lever and a second lever; and said fastening device is installed at the juncture between said first lever and second lever to adjust the combined lengths of the two levers.

3. The work light stand as in claim 2, wherein said fastening device is a notched ring structure, whereby a body core connects across the ends of a notch of said notched ring such that one end of said body core is fixed in position and the other end is hinged to said working lever so that said working lever can tighten in said notch via the body core and thereby fasten said adjustable lever at fixed length.

4. The work light stand as in claim 3, wherein said body core is a screwed socket, where one end of said screwed socket is fastened with a screw and fixed onto said ring structure, and said screw can adjust the degree of tightness as said working lever tightens in said notch.

5. The work light stand as in claim 1, wherein said adjustable lever is comprised of a first lever, a second lever and a third lever; such that a fastening device is respectively installed at the respective juncture between the first lever and the second lever and between the second lever and the third lever.

6. The work light stand as in claim 1, wherein said supporting legs comprise adjustable legs, and the respective lengths of said adjustable legs can be adjusted by said fastening device.

7. The work light stand as in claim 1, further comprises a cross lever for installing the light thereon, and the adjustable lever is installed and connected to said cross lever.

8. A work light stand with at least one light is installed thereon, the work light stand comprising:
an adjustable lever, the length of which is fixable by a fastening device;
supporting legs hinged to said adjustable lever in order to maintain said work light stand in the upright standing position;
said adjustable lever comprises of a first lever and a second lever, said first lever can fit into said second lever, and said fastening device is installed at the juncture between the first lever and the second lever;
said fastening device is of a notched ring structure wherein a body core pierces across said notch;
a working lever having a tip is hinged to one end of the body core can tighten in said notch to tighten or loosen said fastening device which in turn fastens or releases therebetween the first lever and the second lever;
wherein said working lever is shaped and configured to axially overlap said adjustable lever when the fastening device is in a closed position; and
rotational axis of said working lever is parallel to longitudinal axis of said adjustable lever, and the tip of said working lever is shaped and configured to curve radially inwards towards said adjustable lever to minimize accidental disengagement of said working lever.
